(19) United States
(12) Patent Application Publication
(10) Pub. No.: US 2015/0112863 A1
(43) Pub. Date: Apr. 23, 2015

(54) METHOD AND SYSTEM FOR CONDUCTING A MONEY TRANSFER AND/OR PAYMENT TRANSACTION

(71) Applicant: MOBILIS NETWORKS LIMITED, Auckland (NZ)

(72) Inventors: Michael Johnston, Auckland (NZ); Ian Allan, Auckland (NZ); Mihal Abuta, Auckland (NZ); Chris Jones, Auckland (NZ)

(21) Appl. No.: 14/395,023

(22) PCT Filed: Apr. 18, 2013
(86) PCT No.: PCT/NZ2013/000072

§ 371 Date: Oct. 16, 2014

Related U.S. Application Data
(60) Provisional application No. 61/635,093, filed on Apr. 18, 2012.

(51) Int. Cl. G06Q 20/32; G06Q 20/38

(52) U.S. Cl. CPC G06Q 20/3227; G06Q 20/382
USPC 705/44

(57) ABSTRACT

The invention provides a method of conducting a money transfer transaction. The method comprises obtaining identification data from a customer at a point-of-sale terminal; verifying the obtained identification data by matching the identification data with customer data maintained in computer memory; obtaining transaction details from the customer, the transaction details including a transaction value and a recipient international mobile subscriber identity (IMSI) associated with a mobile device; displaying a summary of the proposed money transfer transaction on a display device in communication with the point-of-sale terminal; obtaining confirmation of the money transfer transaction from the customer; obtaining payment from the customer representing the transaction value; and associating the transaction value with the recipient IMSI. Also provided are methods of conducting a payment transaction and related money transfer and payment transaction systems.

### FIELD OF INVENTION

The invention relates to a method and system for conducting a money transfer and/or payment transaction.

### BACKGROUND TO INVENTION

Near field communication (NFC) is being used increasingly frequently in mobile payment systems.

Currently NFC-based mobile payments require an NFC chip embedded in a smart phone. That NFC chip is linked to a secure element within the phone. The secure element stores credit card and PIN information. There are risks as the secure element is potentially subject to security breaches. Furthermore, the smart phone requires a special application to process the transactions and manage security.

It is an object of preferred embodiments of the present invention to address some of the aforementioned disadvantages. An additional or alternative object is to at least provide the public with a useful choice.

### SUMMARY OF INVENTION

In one embodiment the invention comprises a method of conducting a money transfer transaction. The method comprises obtaining identification data from a customer at a point-of-sale terminal; verifying the obtained identification data by matching the identification data with customer data maintained in computer memory; obtaining transaction details from the customer, the transaction details including a transaction value and a recipient international mobile subscriber identity (IMSI) associated with a mobile device; displaying a summary of the proposed money transfer transaction on a display device in communication with the point-of-sale terminal; obtaining confirmation of the money transfer transaction from the customer; obtaining payment from the customer representing the transaction value; and associating the transaction value with the recipient IMSI.

Preferably the identification data includes a biometric identifier.

Preferably the identification data includes customer name and customer date of birth.

Preferably verifying the obtained identification data includes the customer presenting a physical identifier, the physical identifier including a passport and/or driver license.

Preferably the transaction details include a destination country.

Preferably the point-of-sale device is located in a first country and the destination country comprises a second country.

Preferably the transaction details include a currency.

In another embodiment the invention comprises a method of conducting a payment transaction. The method comprises obtaining identification data from a customer at a point-of-sale terminal; verifying the obtained identification data by matching the identification data with customer data maintained in computer memory; obtaining transaction details from the customer, the transaction details including a payee, a transaction value, and a transaction identifier; displaying a summary of the proposed payment transaction on a display device in communication with the point-of-sale terminal; obtaining confirmation of the payment transaction from the customer; obtaining payment from the customer representing the transaction value; and transferring remittance comprising the transaction value to a financial institution associated with the payee.

Preferably the identification data includes a biometric identifier.

Preferably the identification data includes a customer name and customer date of birth.

Preferably verifying the obtained identification data includes the customer presenting a physical identifier, the physical identifier including a passport and/or driver license.

Preferably the transaction details include a destination country.

Preferably the point-of-sale device is located in a first country and the destination country comprises a second country.

Preferably the transaction identifier comprises a payee reference number.

In a further embodiment the invention comprises a method of conducting a payment transaction. The method comprises obtaining transaction details from a customer at a point-of-sale terminal, the transaction details including a transaction value and an international mobile subscriber identity (IMSI) associated with a mobile device; initiating a push notification request to the IMSI, the push notification request including some or all of the transaction details and an authorisation request; receiving an authorisation message from the mobile subscriber number; and transferring remittance comprising the transaction value to a financial institution.

Preferably obtaining the IMSI comprises obtaining an identifier of a Near Field Communication (NFC) chip associated with the mobile device and obtaining the IMSI from a data store of IMSI-NFC identifier associations.

Preferably obtaining the IMSI comprises the customer entering the IMSI into a data entry device in communication with the point-of-sale terminal.

Preferably the authorisation request comprises a request to enter a Personal Identification Number (PIN) on the mobile device associated with the IMSI.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

### BRIEF DESCRIPTION OF FIGURES

Preferred forms of the method and system for conducting a money transfer and/or payment transaction will now be described by way of example only with reference to the accompanying figures in which:

FIG. 1 shows a preferred form system in which aspects of the invention are implemented.

FIGS. 2a to 2d illustrate a preferred form use case for conducting a money transfer.

FIGS. 3a to 3d show a preferred form use case for conducting a payment transaction.

FIGS. 4a to 4e show a further use case involving a payment transaction.

FIGS. 5, 6 and 7 show a preferred form process for international remittance.

FIGS. 8, 9 and 10 show a preferred form process for international bill payment.

FIGS. 11 and 12 show a preferred form process for merchant payment.

FIG. 13 shows a preferred form server arrangement.

FIG. 14 shows a preferred form point-of-sale terminal.

### DETAILED DESCRIPTION

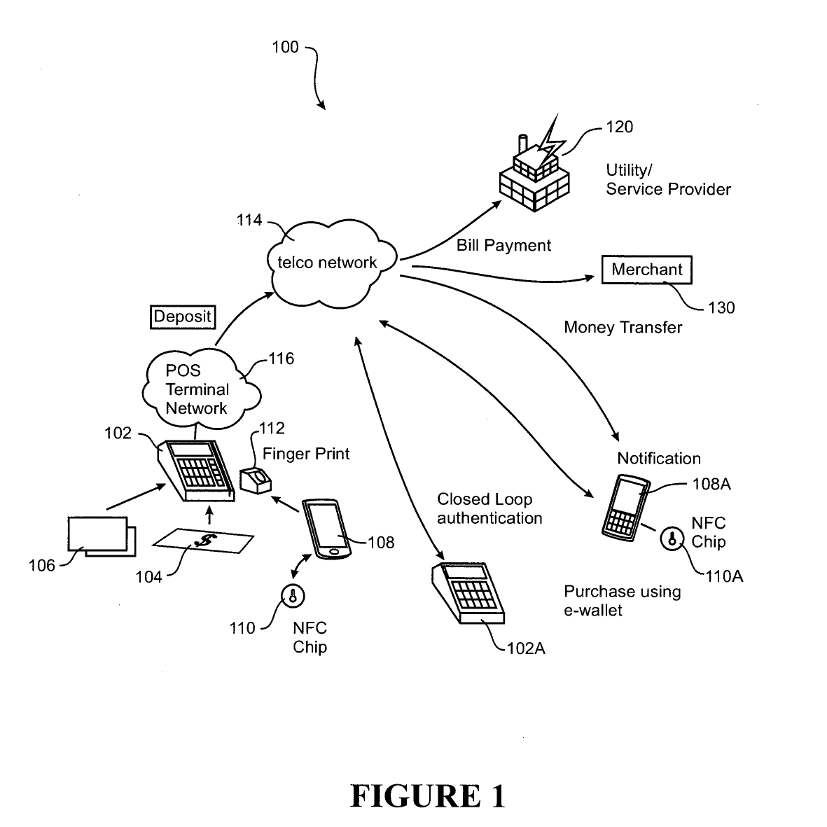

FIG. 1 shows a preferred form system 100 in which aspects of the invention are implemented. The system includes a point-of-sale (POS) terminal 102 which is typically operated by a merchant (not shown). The POS terminal operates under control of applications developed and compiled suitable to control a processor within the POS terminal. These applications include the use of Near Field Communications (contactless) devices and biometric fingerprint scanning as well as the more traditional functions of pinpad entry and magnetic card swipe.

A customer (not shown) makes payment either to the merchant or to other participants in the system with cash 104 or payment card 106. Payment cards 106 include magnetic stripe and chip cards, and include credit cards, debit cards and charge cards.

The customer operates a mobile device 108. The mobile device has associated with it an international mobile subscriber identity (IMSI). The IMSI represents a unique telephone number within a telephone and/or cellular network.

The mobile device 108 further includes an identifier of a near field communication (NFC) chip 110 that is associated with the mobile device 108. In some embodiments the NFC chip 110 is integral with a SIM card on which is stored the IMSI associated with the mobile device. In other circumstances, particularly with low cost mobile devices, the NFC chip 110 is affixed physically to the mobile device 108. The NFC chip 110 is either external or internal of the casing of the mobile device 108.

The system optionally includes a biometric scanner 112. In the example shown in FIG. 1 the biometric scanner 112 is a fingerprint reader. It will be appreciated that in alternative or additional embodiments the biometric scanner 112 scans retinas or analyses DNA samples from the customer.

The POS terminal 102 and the mobile device 108 are in communication with a telecommunications network 114. It will appreciated that there could be one or more additional networks that work in co-ordination with the telecommunications network 114. These additional networks include a POS terminal network 116.

The system 100 includes additional POS terminals and mobile devices. One example is shown as POS terminal 102A, mobile device 108A and NFC chip 110A.

Also connected to the telecommunications network 114 are one or more utility providers and merchants. Examples are shown in FIG. 1 of a utility/service provider 120 and a merchant 130. It will be appreciated that the diagram has been simplified. Bill payments will not necessarily go directly to the utility provider 120 or the merchant 130. Payments would typically go to a financial institution associated with one of these entities. In one embodiment this financial institution is maintained in direct association with the utility provider or merchant. In another embodiment there is a payment gateway interposed between the telco network 114 and the utility provider or merchant.

It will also readily be apparent that system 100 is not confined to one geographic region. It is anticipated for example that the operator of mobile device 108 resides in a different country to the operator of mobile device 108A. In one embodiment the POS terminal 102 and the user with mobile device 108 are located in one country and the POS terminal 102A and the user of mobile device 108A are located in a different country.

### Send Money Use Case

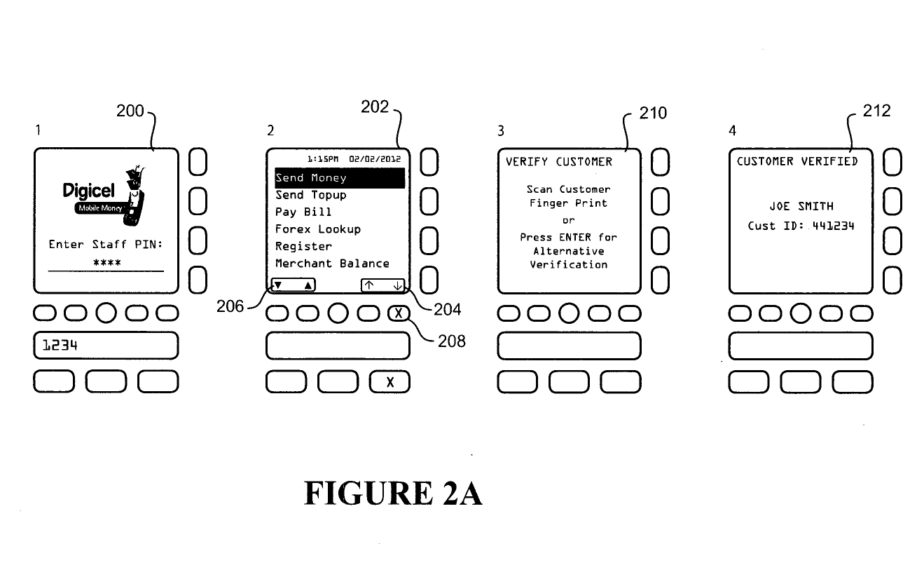

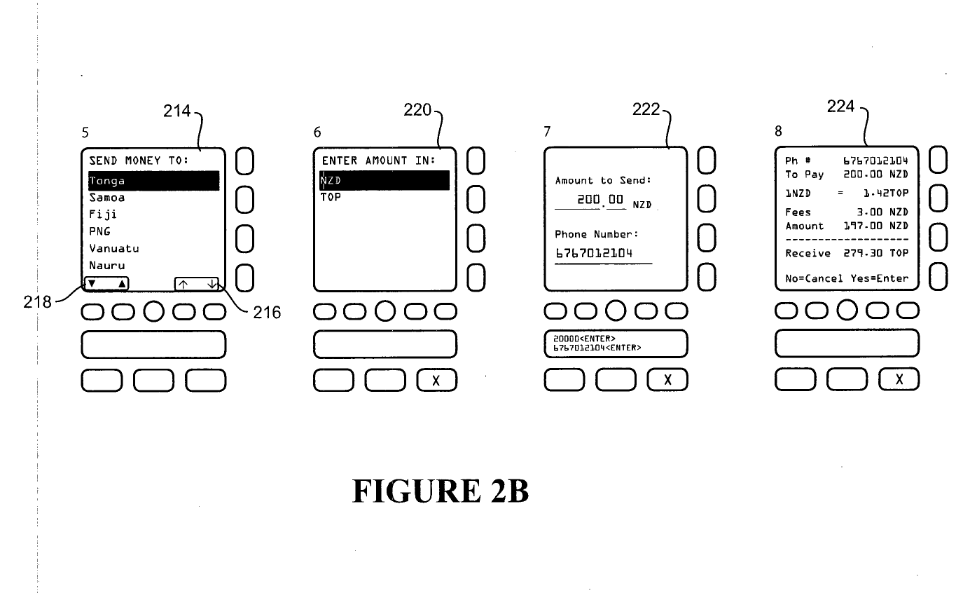

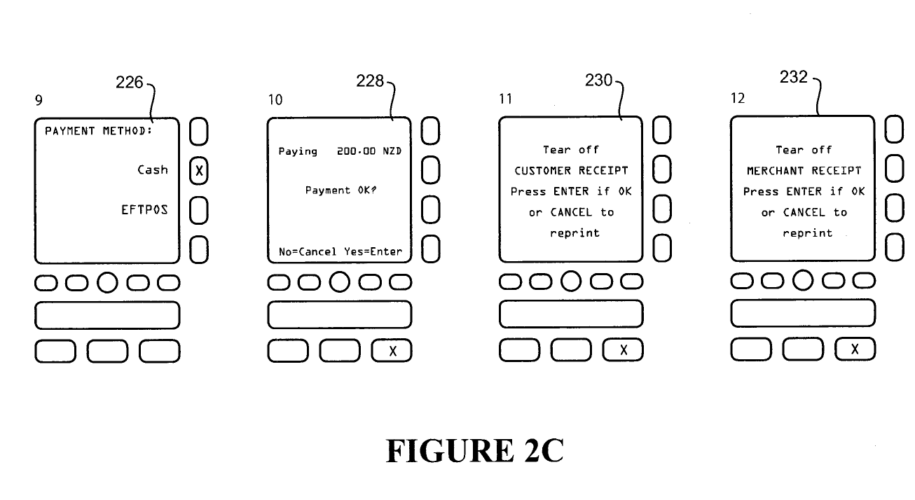

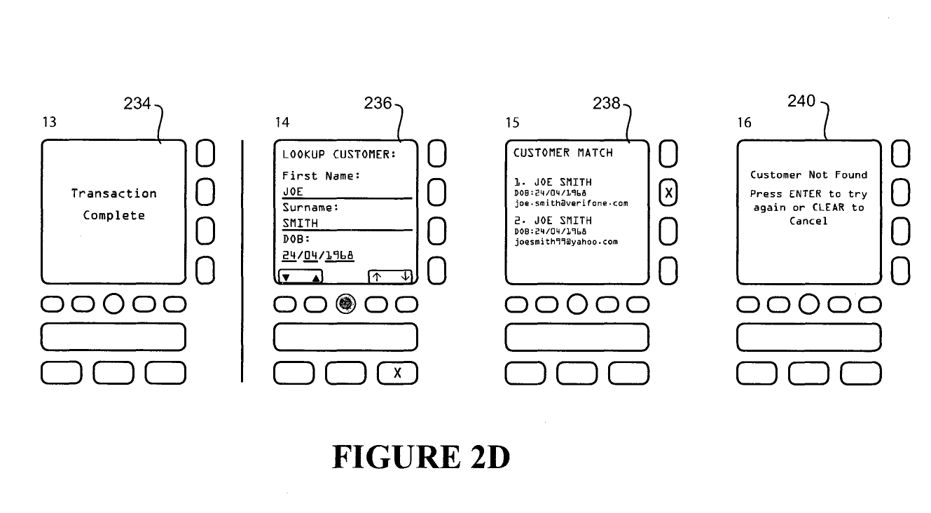

Operation of the system is now described with reference to several use cases. The first use case is described with reference to FIGS. 2A-2D. It involves an example where a customer in proximity to POS terminal 102 sends currency or funds to a user of mobile device 108A. The use case shows the result of executing functions on the POS terminal 116. These functions are the result of computer software executed on the POS terminal 116.

Shown at 200 is the first screen shown on a display device of the POS terminal 102. As shown in display 200 a staff member from the merchant is prompted to enter a personal identification number (PIN). In this case it is assumed that merchants assign individual PINs to individual staff.

As shown in 202 the merchant is prompted to select a function for the POS terminal 102 to perform. The highlighted ‘send money’ function is the one that is described below. The merchant user is able to select an individual item from the list by using up and down arrows 204 to move through menu items. The up and down arrows 206 typically move between screens. Pressing the cancel button 208 causes control to pass back to display 200.

It is then necessary to obtain identification data from the customer. In an optional embodiment the user is prompted 210 to use the biometric scanner 112. The customer places a finger on the biometric scanner 112. A search is made by matching the identification data in the form of a biometric identifier with customer data maintained in computer memory. If there is a match then control is passed to the next step 4. If there is no match control is passed to step 16 below.

Alternatively the user is able to request alternative verification by pressing the enter key. This causes the POS terminal 102 to step forward to step 14 for a fallback verification routine. The alternative verification routine looks up the customer based on customer name. The user is also required to produce physical identification.

Step 4 as shown at 212 confirms to the merchant that the customer has been verified. Preferably the display also shows a customer identifier associated with the customer. Following verification it is then necessary to obtain transaction details from the customer.

Step 5 as shown at 214 permits the customer to select a destination country for the transfer of funds. The customer is able to move up and down the menu items using the up and down arrows 216. The customer is also able to move between screens using up and down arrows 218. In one embodiment there is an alternative screen showing additional international destinations in order of popularity or in alphabetical order.

Once the user has selected a destination country step 6 shown at 220 permits the user to select a currency. In one embodiment the user is prompted to select a currency. This option is required for example where the destination country is different to the country of residence of the user.

Step 7 shown at 222 permits a user to enter a transaction value. As shown in the figure, the customer also enters a recipient international mobile subscriber identity (IMSI). This IMSI is typically associated with a mobile device for example mobile device 108A.

As shown in step 8, the user is presented with a display showing the proposed transaction details. Preferred form transaction details include a transaction value and a recipient international mobile subscriber identity (IMSI). Transaction details optionally include a currency and a fee amount for the transaction.

The display is typically integral with the POS terminal 102 or alternatively could be interfaced to the POS terminal 102. In any case, the POS terminal 102 is in communication with the display. This verification step 8 provides a chance for the customer to decline the transaction.

If the customer is satisfied with the transaction the user is able to select 226 a payment method. The user in this case selects either cash or eftpos. It will be appreciated that eftpos permits a user to use a mag stripe or chip card to make payment. This payment card could in turn comprise a credit card, debit card or charge card.

As shown at step 10 at 228 the user is presented on the display with confirmation of payment. If the user is satisfied with the payment the control passes to step 11 as shown at 230 which prompts the withdrawal of a receipt for the customer.

As shown at step 12 a merchant receipt is also printed and a transaction complete message is presented at step 13 shown at 234.

Step 14 shown at 236 permits an alternative method for a customer to provide identification data. In this case the identification data obtained from the customer includes the customer name and date of birth. This identification data is matched with customer data maintained in computer memory. If there is a match then control passes to step 15 as shown at 238. Alternatively if there is no match then an error message is shown at step 16 at 240.

### Bill Payment Use Case

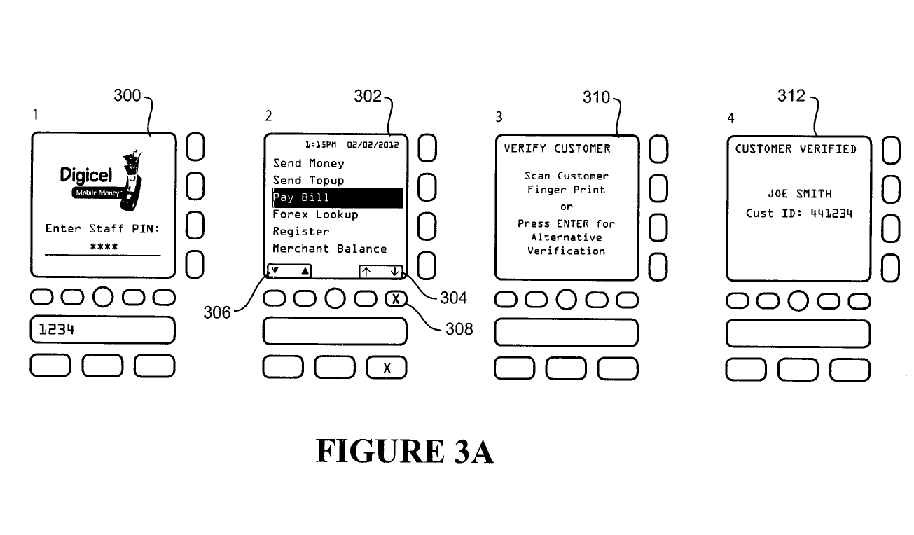

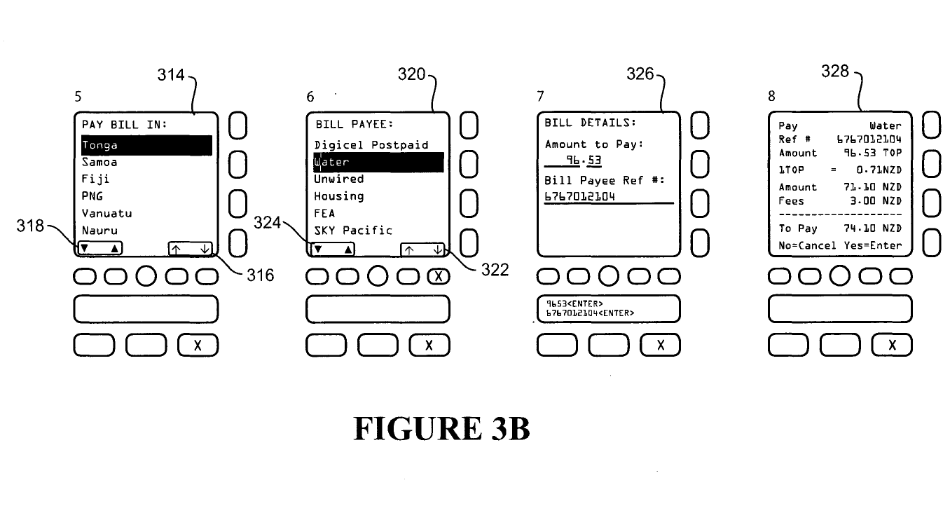

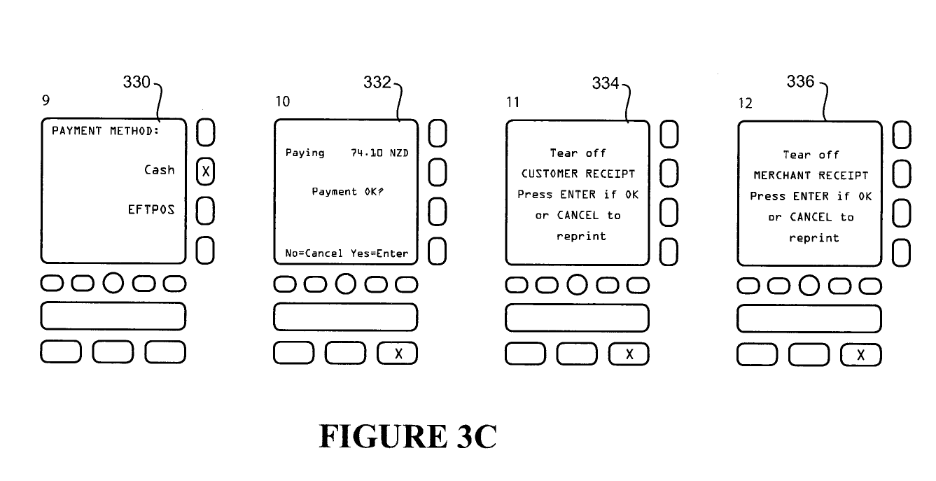

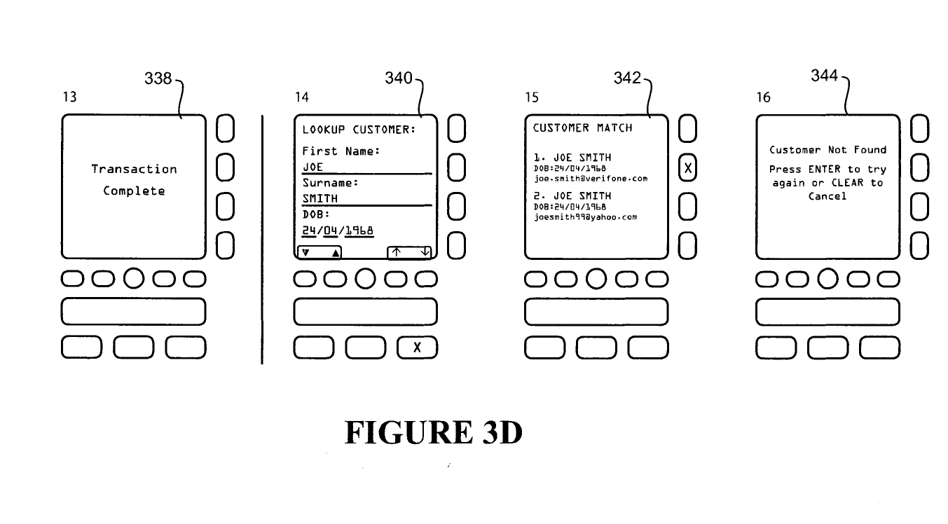

A further use case involves the direct payment of bills for example bills issued by utility or service providers. This feature is further described with reference to FIGS. 3A to 3D.

Step 1 shown at 300 is the same as that shown above with reference to item 200. The merchant or merchant staff member enters a PIN in order to access the system.

Step 2 shown at 302 permits the user to select the bill payment menu option. Once again the up and down arrows 304 move through menu items. The up and down arrows 306 permit the user to move between screens. Once again if the user selects the cancel button 308 control passes back to step 1.

Step 3 shown at 310 permits verification of the customer. This verification step is performed in essentially the same manner as that described above with reference to verification step 210. Similarly the customer verified confirmation screen 312 proceeds in the same way as verification screen 210 described above.

As shown in step 5 at 314 the user selects a country in which to pay the utility or service provider bill. Once again the customer is able to use the up and down arrows 316 to move through menu items and the up and down arrows 318 to move between screens. Once again the next screen (not shown) provides additional international destinations. These could be presented in order of popularity or alphabetical.

Step 6 shown at 320 permits the user to select a payee. Once again the user is able to move through the menu items using up and down arrows 322 and can move between screens using arrows 324. In one embodiment the next screen provides more bill payee options.

Once the user has selected the bill payee the customer is prompted at step 7 shown at 326 to enter a transaction amount and a transaction identifier. In one preferred form the transaction identifier is the payee reference on the bill.

As shown in step 8 at 328 the customer is presented with a transaction summary and is asked to confirm or to cancel the transaction.

Steps 9, 10, 11 and 12 are indicated at 330, 332, 334 and 336 respectively. These steps proceed in much the same way as that described above with reference to steps 9, 10, 11 and 12 at 226, 228, 230 and 232 respectively.

Similarly steps 13, 14, 15 and 16 are indicated at 338, 340, 342 and 344. These proceed in the same way as steps 13 to 16 indicated above at 234, 236, 238 and 240 respectively.

### Merchant Payment Use Case

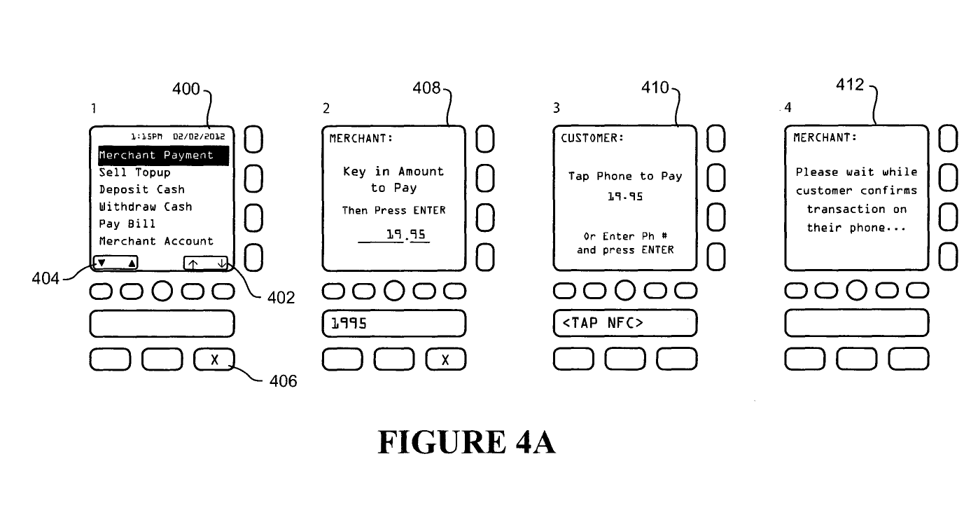

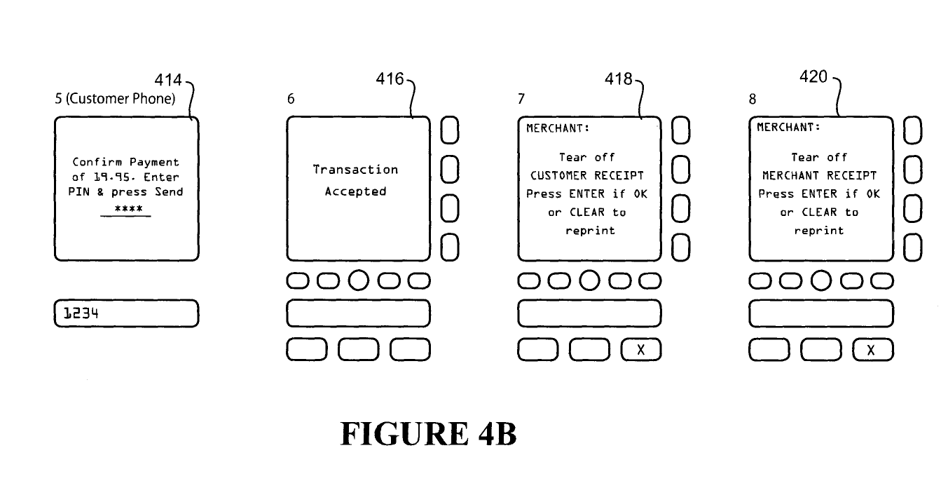

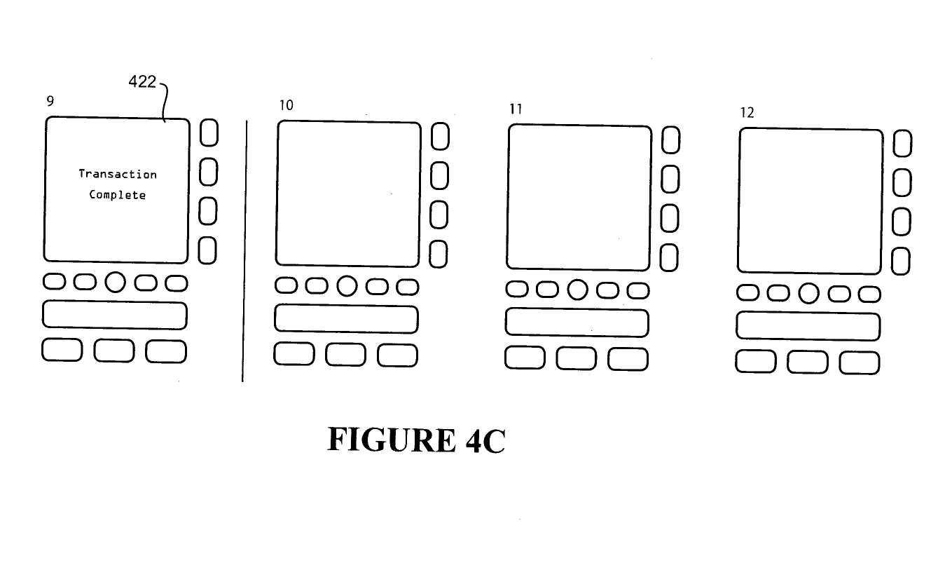

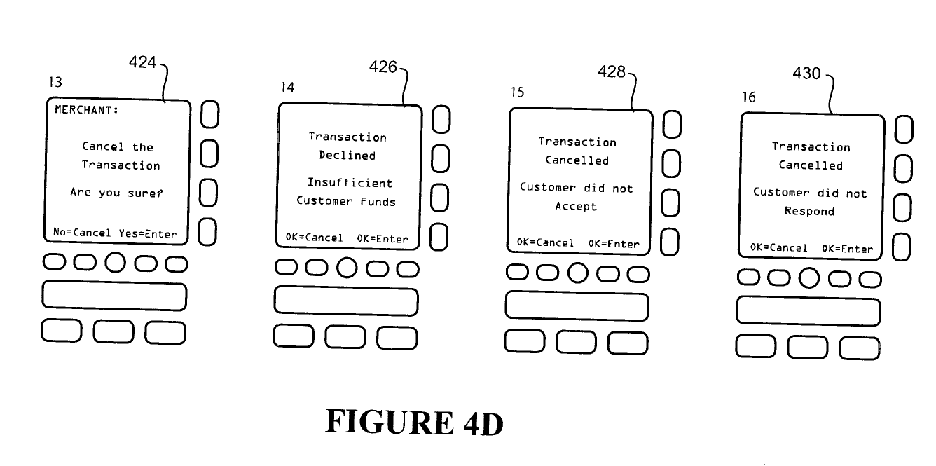

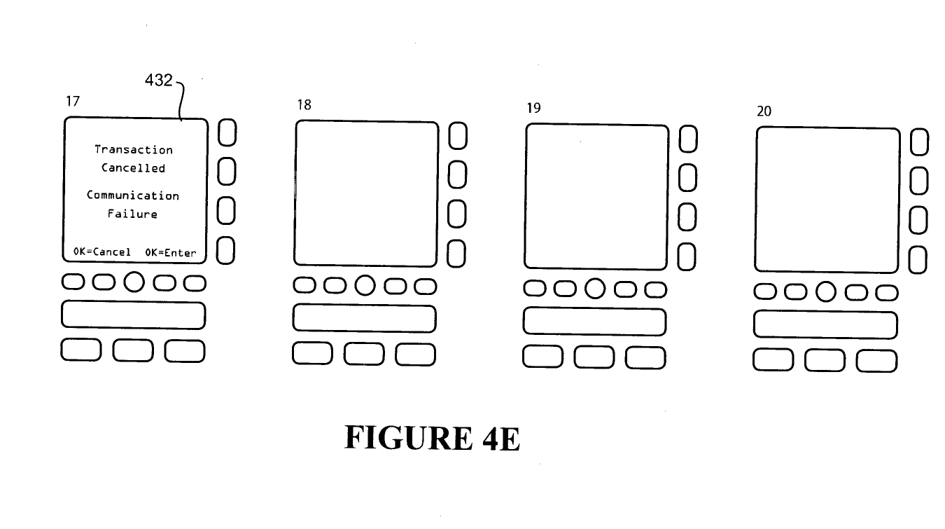

FIGS. 4A to 4E below show a further use case involving merchant payment. As shown in step 1 at 400 the merchant selects the ‘merchant payment’ menu option. Once again, up and down arrows 402 move through menu items and up and down arrows 404 move between screens.

It is assumed here that the merchant has already entered a PIN using a screen similar to that shown at 200 or 300 above. Pressing cancel 406 takes the user back to the initial PIN entry screen. At step 2 shown at 408 the merchant enters an amount to pay in domestic currency.

As shown at step 3 at 410 the customer provides an international mobile subscriber identity (IMSI) associated with the customer's mobile device for example mobile device 108. There are many ways for a customer to provide the IMSI to the merchant.

One example involves an NFC chip 110 that is fitted to the mobile device 108. The customer brings the NFC chip 110 in close proximity to the merchant equipment. This is known as ‘a tap phone’ process. The IMSI is transmitted using NFC to the POS terminal 102.

Alternatively where the user is not fitted with an NFC chip 110, or according to user preference, the user is able to enter an IMSI number manually.

One potential benefit of using an NFC chip 110 that is fitted to the mobile device 108 is that there is a broad selection of NFC tags or stickers and a broad selection is mobile phones or smart phones available. Substantially all intelligence and security is managed on the server side of the system. This has the potential advantage of being able to offer the same contactless payments, secure PIN entry, vouchering/coupons, and payment thresholds to a mobile subscriber using an entirely rudimentary phone as the system can for a subscriber with the very latest NFC smart phone.

This benefit arises from having the NFC identifier and the IMSI on the server side, and the PIN associated with the IMSI.

Step 4 indicated at 412 shows a preferred form display to the merchant asking the merchant to wait while customer details are confirmed. A push notification request is initiated and transmitted to the IMSI provided by the customer in step 3. It is anticipated that in some cases the customer will be associated with the IMSI entered in step 3. In other cases the customer will have provided another person's IMSI. An SMS text message for example is sent to the IMSI asking for authorisation. In this way the push notification request includes an authorisation request.

There is a preferred form time out period of 30 seconds. This period could be longer or shorter. If the customer does not confirm within 30 seconds by entering a correct personal identification number (PIN) then the request times out. There are other ways in which the transaction is terminated for example if the user or merchant cancels the transaction or if there is a communication error with the server.

A preferred form push notification request including an authorisation request is shown at step 5 at 414. The user is asked to confirm the transaction value. The user is prompted to enter a PIN to confirm the transaction.

If the customer has sufficient funds then control passes to step 6 shown at 416 in which the user to which the push notification request has been sent is advised that the transaction has been accepted. The merchant at step 7 shown at 418 is instructed to tear off a customer receipt and at step 8 shown at 420 is instructed to tear off a merchant receipt. A transaction complete notice is then displayed at step 9 shown at 422. The customer receives an SMS receipt of the transaction.

Step 13 shown at 424 arises from step 4 where the merchant has elected to cancel the transaction. The merchant is prompted to confirm the cancellation.

Step 14 shown at 426 shows an example where a customer does not have sufficient funds in their account. The transaction is declined.

Step 15 shown at 428 illustrates an example where the customer did not accept the transaction and step 16 shown at 430 shows an example where the customer did not respond within the specified time for response.

Finally step 17 shown at 432 illustrates an example where a transaction is cancelled due to communication failure.

### Send Money Process

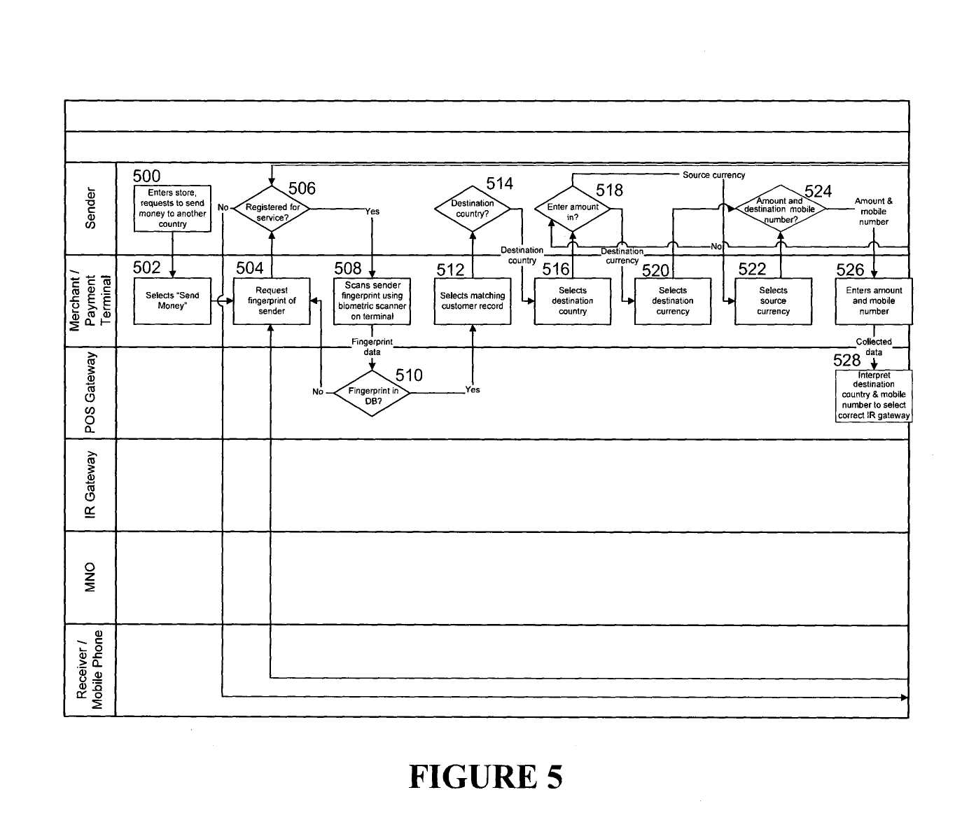

The preferred form process for sending money, also known as international remittance, is further described with reference to FIGS. 5, 6 and 7.

As indicated at 500, the sender enters a store and makes a request to send money to another country. The merchant, operating a POS terminal, selects 502 the ‘send money’ option. The merchant then requests 504 a fingerprint or other biometric identifier of the sender.

If 506 the sender is registered for the service then the merchant scans 508 the sender fingerprint using a biometric scanner on the terminal. The POS gateway then checks 510 to identify whether or not the sender fingerprint is in a stored database. If the fingerprint is not in a stored database then a further request 504 is made for the fingerprint of the sender.

As shown at 506, if the sender is not registered for the service then control passes to a registration process described further below.

If the sender fingerprint is in the database then the merchant/payment terminal selects 512 the matching customer record. If 514 the sender has a preferred destination country then the merchant/payment terminal selects 516 the destination terminal.

If 518 the sender enters an amount then the merchant/payment terminal selects 520 a destination currency and selects 522 a source currency.

If 524 the customer has a preferred amount and destination mobile number then the merchant/payment terminal enters 526 the amount and mobile number. The collected data is then interpreted 528 to interpret the destination country and mobile number in order to select the correct IR gateway.

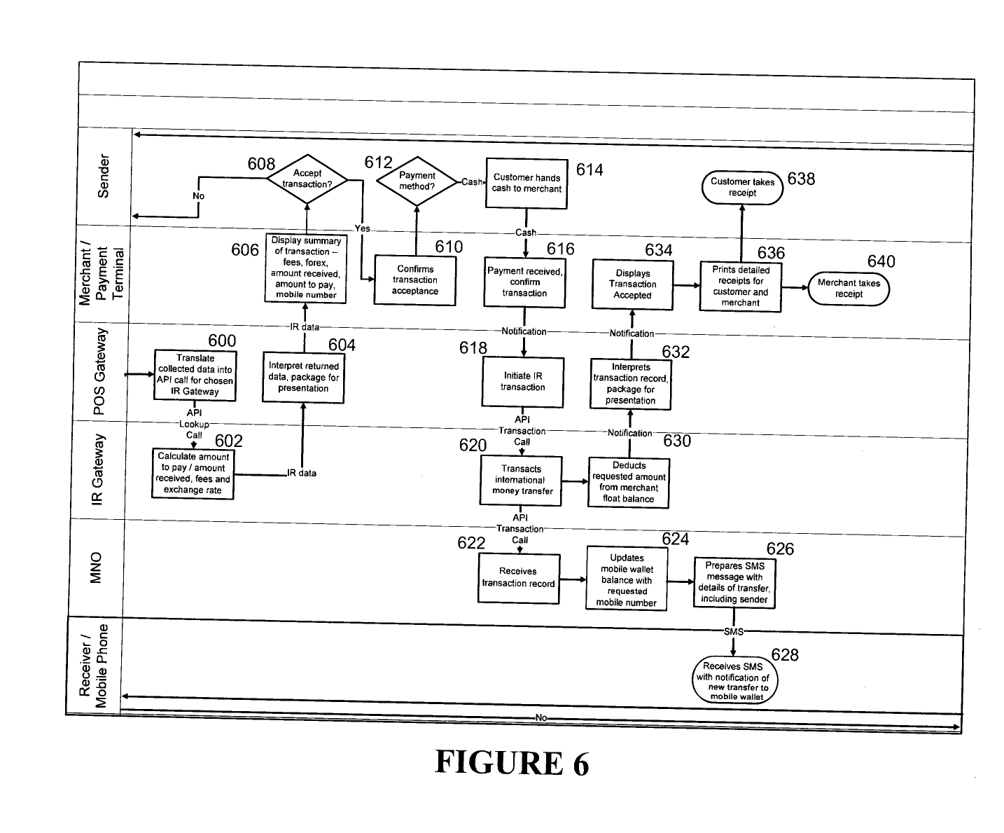

Referring to FIG. 6, the POS gateway translates 600 the collected data into an API call for a chosen IR gateway. Using an API Lookup call the IR gateway calculates 602 the amount to pay/amount received, fees and exchange rate.

The IR data is then passed back to the POS gateway for the gateway to interpret 604 the returned data and package for presentation.

The merchant/payment terminal displays 606 a summary of the transaction. This summary for example includes fees, foreign exchange information, amount received, amount to pay and the mobile number. The customer is then provided the option 608 of accepting or declining the transaction. If the sender declines the transaction then control is passed back to step 518 in which the sender is asked to enter an amount. If the sender does accept the transaction then the merchant/payment terminal confirms 610 the transaction acceptance.

There is then an option for the sender to specify 612 a payment method. If the payment method is cash then the customer hands 614 the cash to the merchant.

The merchant/payment terminal receives 616 the payment and confirms the transaction. The POS gateway initiates 618 the IR transaction. Using an API transaction call the IR gateway transacts 620 an international money transfer.

The MNO receives 622 the transaction record and updates 624 the mobile wallet balance for the requested mobile number. An SMS message is then prepared 626 with details of the transfer including the sender. An SMS text message is then sent to the receiver/mobile phone. The receiver/mobile phone receives 628 an SMS with notification of the new transfer to the mobile wallet.

After the IR gateway transacts 620 the international money transfer the gateway deducts 630 the requested amount from the merchant float balance. A notification is then passed back to the POS gateway. The POS gateway interprets 632 the transaction record and packages for presentation. Following the notification, the merchant/payment terminal displays 634 the fact that the transaction has been accepted. The terminal prints 636 detailed receipts for the customer and the merchant. The customer takes 638 a receipt and the merchant takes 640 a receipt.

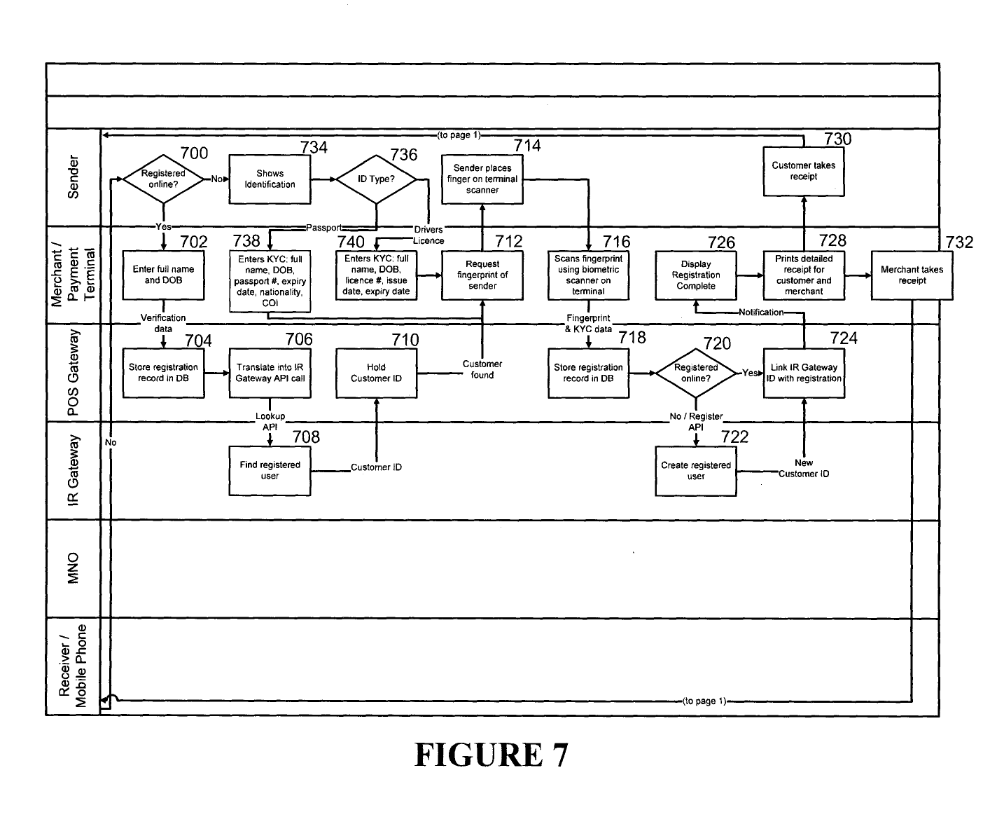

FIG. 7 illustrates a process followed if the sender is not registered 506 for the service. If 700 the user has registered online then the merchant enters 702 the full name and date of birth of the customer. Verification data is then transmitted to the POS gateway for the POS gateway to store 704 the registration record in the database. The POS gateway translates 706 the data into an IR gateway API call. Following a Lookup API the IR gateway locates 708 the registered user.

The POS gateway holds 710 the customer identifier. The merchant/payment terminal requests 712 the fingerprint or other biometric identifier of the sender. The sender places 714 a finger on the finger terminal scanner. The merchant/payment terminal scans 716 the fingerprint using a biometric scanner on the terminal.

This fingerprint and KYC (know your customer) data is then passed to the POS gateway. The POS gateway stores 718 the registration record in the database. If 720 the sender is not registered online then a registered user record is created 722 by the IR gateway. The newly created customer identifier, or the existing customer identifier, is then linked 724 by the POS gateway.

A notification is sent to the merchant/payment terminal to display 726 the fact that the registration is complete. The merchant/payment terminal prints 728 a detailed receipt for the customer and the merchant. The customer takes 730 a receipt and the merchant takes 732 a receipt.

If 700 the user has not registered online then the sender shows 734 an identification. If 736 the identifier is a passport then the merchant/payment terminal enters 738 KYC information including full name, date of birth, passport number, expiry date, nationality and a COI value.

If the ID type 736 is a driver license then the merchant/payment terminal enters 740 KYC information including full name, date of birth, driver license number, issue date and expiry date. Control is then passed to 712 in which the fingerprint of the sender is requested.

### Bill Payment Process

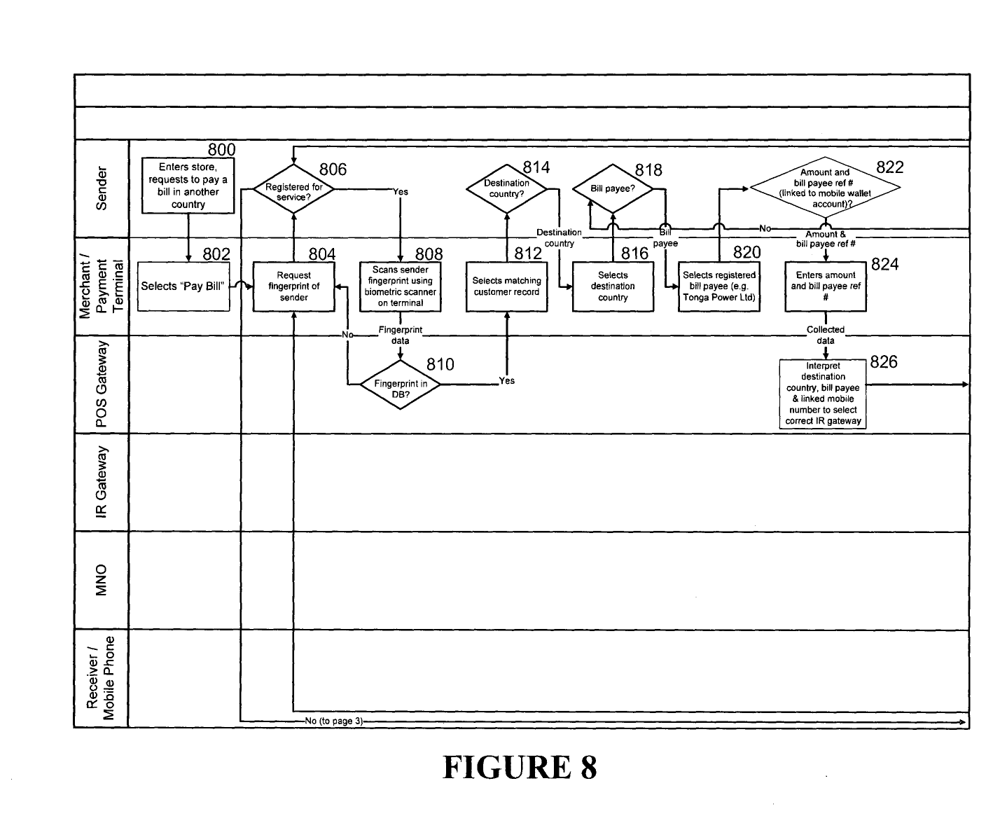

A preferred form process for international bill payment is further described below with reference to FIGS. 8, 9 and 10.

As indicated at 800, the sender enters a store and makes a request to pay a bill in another country. The merchant, operating a POS terminal, selects 802 the ‘pay bill’ option. The merchant then requests 804 a fingerprint or other biometric identifier of the sender.

If 806 the sender is registered for the service then the merchant scans 808 the sender fingerprint using a biometric scanner on the terminal. The POS gateway then checks 810 to identify whether or not the sender fingerprint is in a stored database. If the fingerprint is not in a stored database then a further request 804 is made for the fingerprint of the sender.

As shown at 806, if the sender is not registered for the service then control passes to a registration process described further below.

If the sender fingerprint is in the database then the merchant/payment terminal selects 812 the matching customer record. If 814 the sender has a preferred destination country then the merchant/payment terminal selects 816 the destination country.

If 818 the sender enters a bill payee then the merchant/payment terminal selects 820 a registered bill payee.

If 822 the customer has a preferred amount and bill payee reference number (preferably linked to a mobile wallet account) then the merchant/payment terminal enters 824 the amount and the bill payee reference. The collected data is then interpreted 826 to interpret the destination country, bill payee and linked mobile number to select the correct IR gateway.

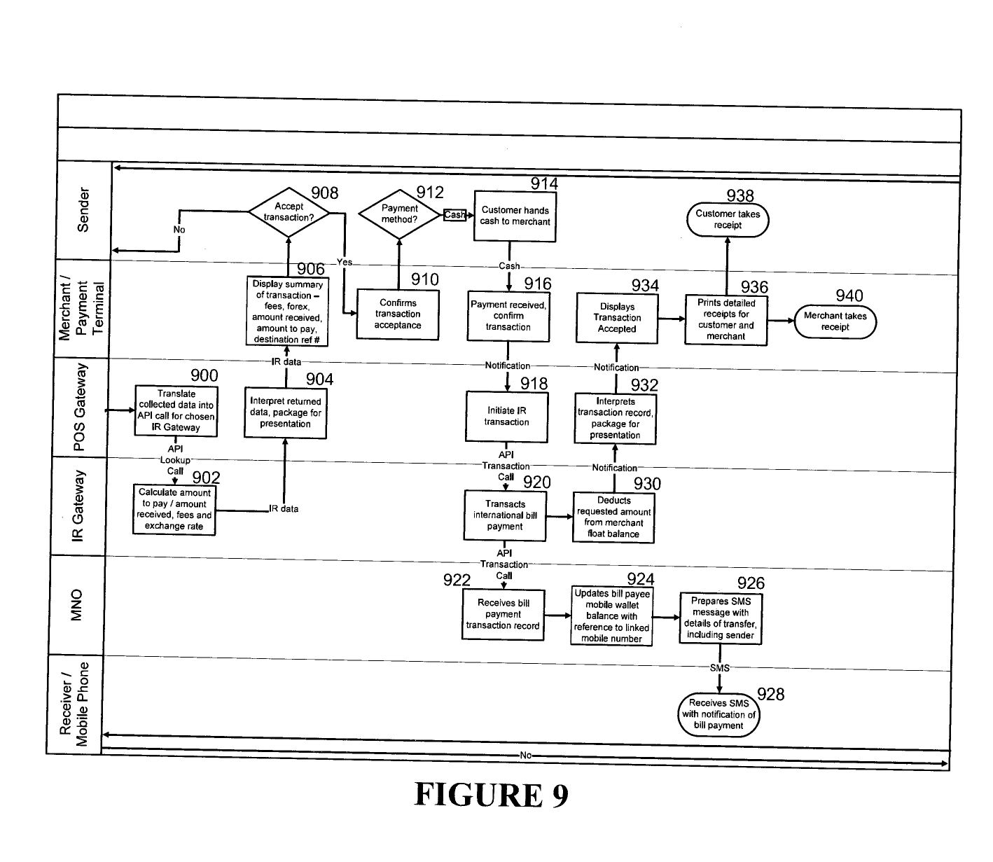

Referring to FIG. 9, the POS gateway translates 900 the collected data into an API call for a chosen IR gateway. Using an API Look up call the IR gateway calculates 902 the amount to pay/amount received, fees and exchange rate.

The IR data is then passed back to the POS gateway for the gateway to interpret 904 the returned data and package for presentation.

The merchant/payment terminal displays 906 a summary of the transaction. This summary for example includes fees, foreign exchange information, amount received, amount to pay and the destination reference number. The customer is then provided the option 908 of accepting or declining the transaction. If the sender declines the transaction then control is passed back to step 818 in which the sender is asked to enter a bill payee. If the sender does accept the transaction then the merchant/payment terminal confirms 910 the transaction acceptance.

There is then an option for the sender to specify 912 a payment method. If the payment method is cash then the customer hands 914 the cash to the merchant. The merchant/payment terminal receives 916 the payment and confirms the transaction. The POS gateway initiates 918 the IR transaction. Using an API transaction call the IR gateway transacts 920 an international bill payment.

The MNO receives 922 the bill payment transaction record and updates 924 the mobile wallet balance for the requested mobile number. An SMS message is then prepared 926 with details of the transfer including the sender. An SMS text message is then sent to the receiver/mobile phone. The receiver/mobile phone receives 928 an SMS text message with notification of the new transfer to the mobile wallet.

After the IR gateway transacts 920 the international bill payment, the gateway deducts 930 the requested amount from the merchant float balance. A notification is then passed back to the POS gateway. The POS gateway interprets 932 the transaction record and packages for presentation.

Following the notification, the merchant/payment terminal displays 934 the fact that the transaction has been accepted. The terminal prints 936 detailed receipts for the customer and the merchant. The customer takes 938 a receipt and the merchant takes 940 a receipt.

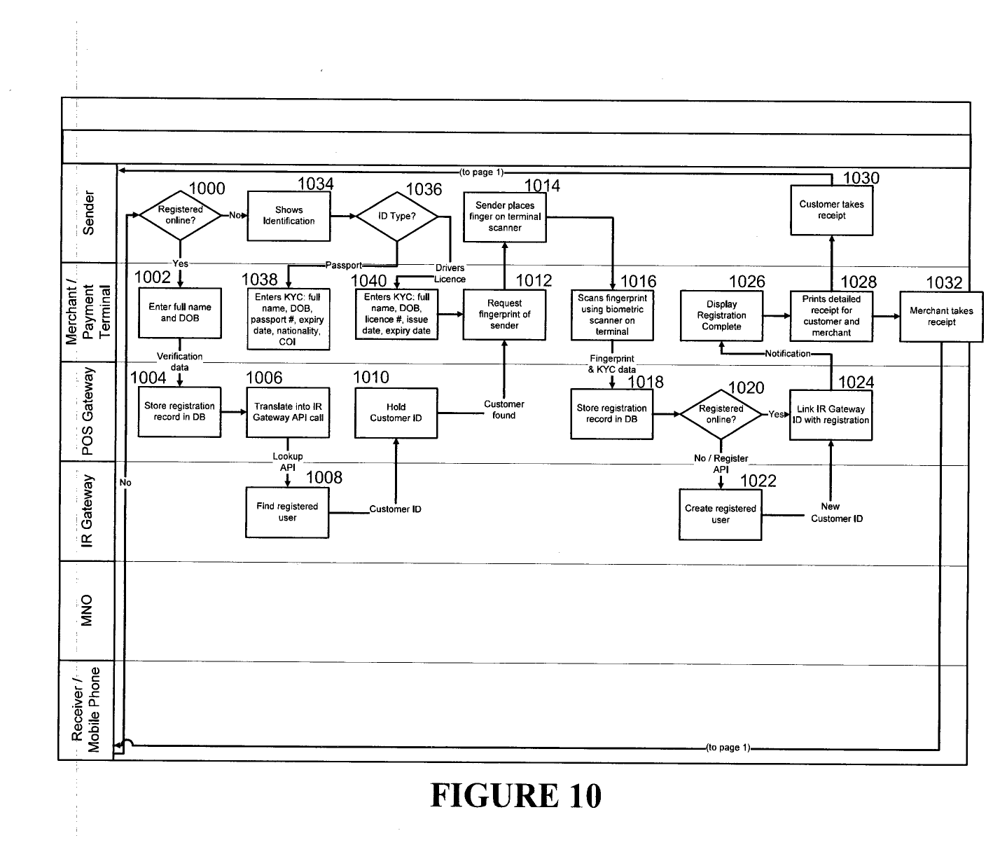

FIG. 10 illustrates a process followed if the sender is not registered 806 for the service. If 1000 the user has registered online then the merchant enters 1002 the full name and date of birth of the customer. Verification data is then transmitted to the POS gateway for the POS gateway to store 1004 the registration record in the database. The POS gateway translates 1006 the data into an IR gateway API call. Following a Lookup API the IR gateway locates 1008 the registered user.

The POS gateway holds 1010 the customer identifier. The merchant/payment terminal requests 1012 the fingerprint or other biometric identifier of the sender. The sender places 1014 a finger on the finger terminal scanner. The merchant/payment terminal scans 1016 the fingerprint using a biometric scanner on the terminal.

The fingerprint and KYC (know your customer) data is then passed to the POS gateway. The POS gateway stores 1018 the registration record in the database. If 1020 the sender is not registered online then a registered user record is created 1022 by the IR gateway. The newly created customer identifier, or the existing customer identifier, is then linked 1024 by the POS gateway.

A notification is sent to the merchant/payment terminal to display 1026 the fact that the registration is complete. The merchant/payment terminal prints 1028 a detailed receipt for the customer and the merchant. The customer takes 1030 a receipt and the merchant takes 1032 a receipt.

If 1000 the user has not registered online then the sender shows 1034 an identification. If 1036 the identifier is a passport then the merchant/payment terminal enters 1038 KYC information including full name, date of birth, passport number, expiry date, nationality and a COI value.

If the ID type 1036 is a driver license then the merchant/payment terminal enters 1040 KYC information including a full name, date of birth, driver license number, issue date and expiry date. Control is then passed to 1012 in which the fingerprint of the sender is requested.

### Merchant Payment Process

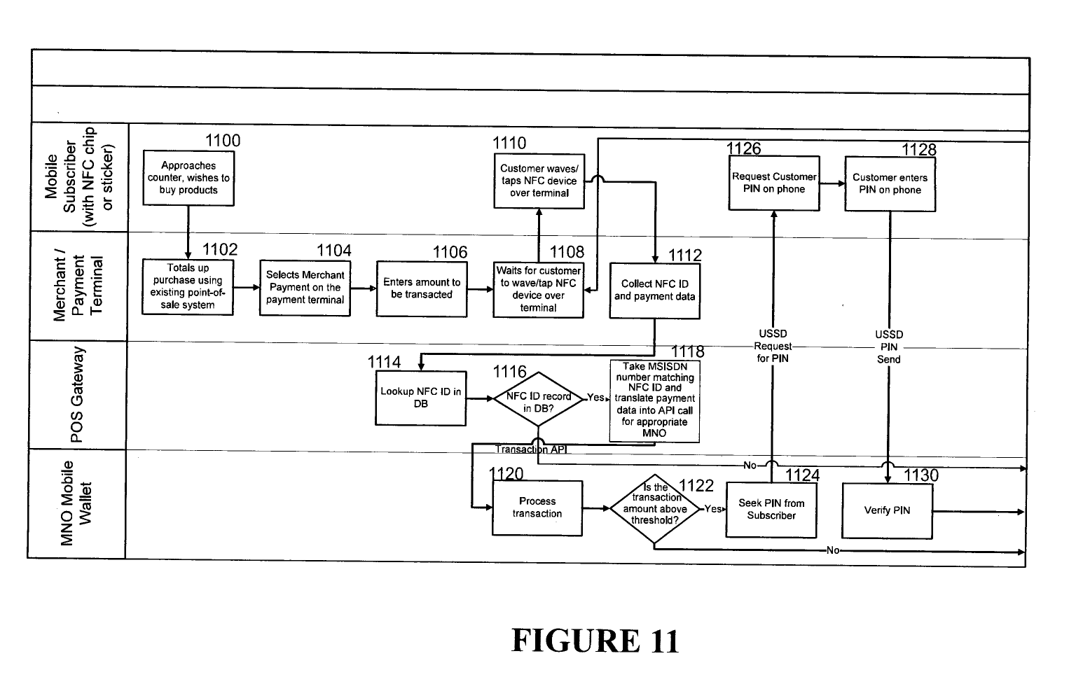

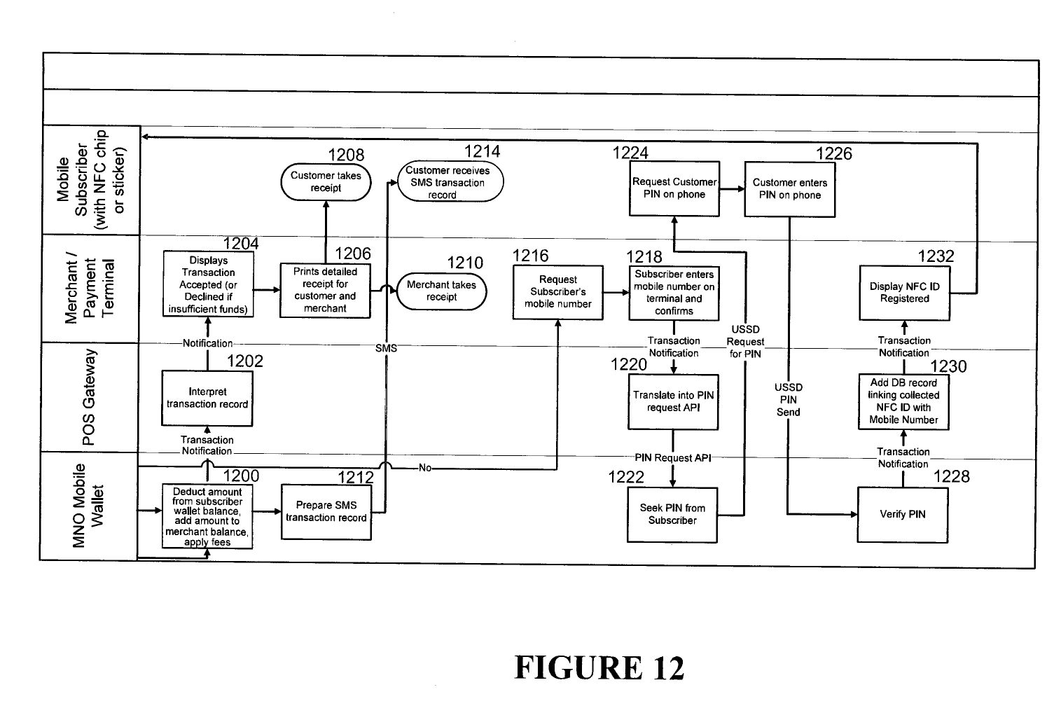

A preferred form process for merchant payment is described below with reference to FIGS. 11 and 12.

A customer approaches 1100 a counter intending to buy one or more products provided by the merchant. The merchant at a payment terminal totals up 1102 the purchase using an existing point-of-sale (POS) system. The merchant then selects 1104 merchant payment on the payment terminal. The merchant enters 1106 the amount to be transacted.

In one preferred embodiment the merchant then waits 1108 for the customer to wave an NFC enabled device over or tap an NFC enabled device on the POS terminal.

The customer waves 1110 the NFC device over or taps the device on the terminal. The merchant/payment terminal collects 1112 the NFC identifier and payment data. The POS gateway performs a Lookup 1114 for the NFC identifier in a database.

If 1116 there is a match then the POS gateway takes 1118 the MSISDN number matching the NFC identifier. The POS gateway translates payment data into an API call for an appropriate MNO.

Using a transaction API the MNO mobile wallet processes 1120 the transaction.

The MNO mobile wallet checks to see whether 1122 the transaction amount is above a threshold. If the transaction amount is within an appropriate threshold the transaction proceeds as will be further described below.

Alternatively if 1122 the transaction is above a predefined threshold then a PIN is obtained 1124 from the subscriber.

The mobile subscriber requests 1126 a custom PIN on the phone. The customer then enters 1128 a PIN on the customer phone. The PIN is then verified 1130.

Referring to FIG. 12 the MNO mobile wallet deducts 1200 an amount from the subscriber wallet balance and adds the amount to a merchant balance. Appropriate fees are applied. This deduction is performed if a transaction is within a threshold 1122 or if a transaction is above a threshold but includes a verified PIN 1130.

Following a transaction notification the POS gateway 1202 interprets the transaction record. Following a notification the merchant/payment terminal displays 1204 the fact that the transaction has been accepted or declined if there are insufficient funds. A detailed receipt is printed 1206 for the customer and the merchant. The customer takes 1208 a receipt and the merchant takes 1210 a receipt.

Following the deduction 1200 the MNO mobile wallet prepares 1212 an SMS transaction record and the customer receives 1214 this SMS transaction record.

In cases where the NFC identifier record is not present in the database 1116, the merchant/payment terminal requests 1216 the subscriber's mobile number. The subscriber enters 1218 the mobile number on the terminal and confirms.

Following a transaction notification the POS gateway 1220 translates the notification into a PIN request API. The MNO mobile wallet seeks 1222 a PIN from the subscriber.

Following a USSD request for the PIN the customer is requested 1224 to provide a customer PIN on the phone. The customer enters 1226 the PIN on the phone. Following a USSD PIN Send the MNO mobile wallet verifies 1228 the PIN. Following a transaction notification the POS gateway adds 1230 a database record linking the collected near frequency identifier with the mobile number.

Following a transaction notification the merchant/payment terminal displays 1232 the fact that the NFC identifier is registered. Control then passes back to the merchant/payment terminal 1108 for the customer to wave or tap the NFC device over the terminal.

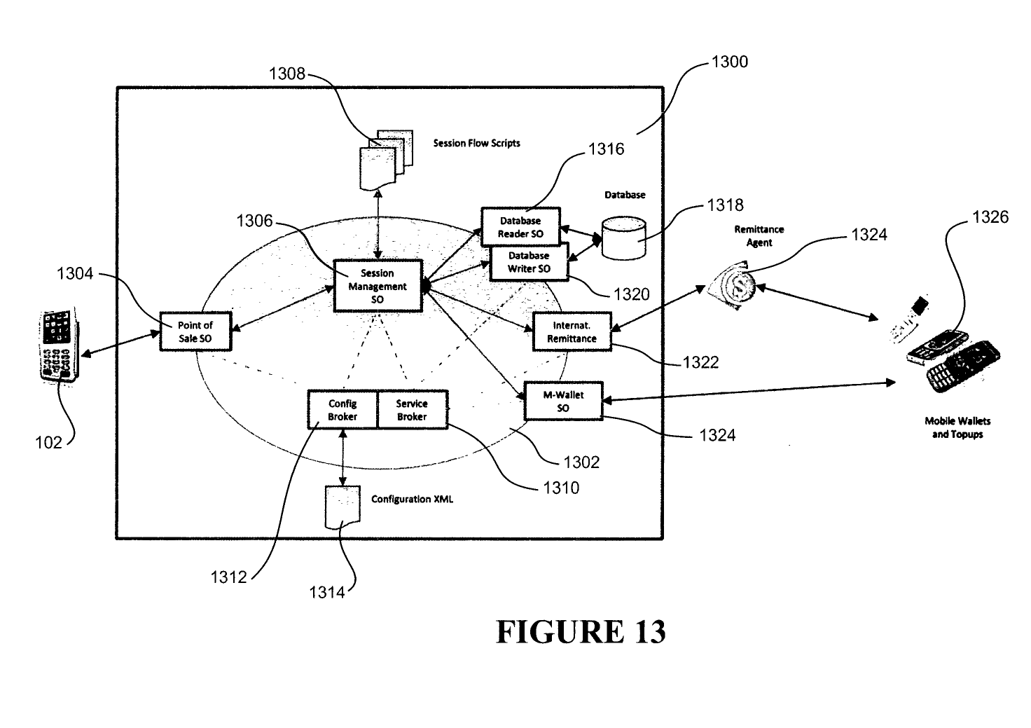

FIG. 13 shows a preferred form server arrangement 1300 running several interconnected software modules. These software modules communicate internally with each other using an asynchronous messaging layer 1302. Messaging layer 1302 facilitates the seamless passing of messages between modules together with inherent monitoring and failover capabilities.

Each module communicating externally is mapped to the appropriate API (application programming interface) of the destination system. It is envisaged that additional modules are developed as connections to new systems are required.

The POS terminal 102 communicates with server 1300 and messaging layer 1302 using an API defined by a point-of-sale service object 1304. The POS terminal uses a secure socket connection between the POS terminal 102 and the server 1300.

Point-of-sale service object 1304 acts as an arbiter between the POS terminal 102 and the messaging layers illustrated at 1302. The POS service object receives name-value pairs (NVPs) from the POS terminal 102. These preferred form NVPs are comma separated data pairs. They are converted into proprietary messages for communication with other modules.

Another function of the point-of-sale service object 1304 is to convert proprietary messages into messages destined for the terminal 102 over the socket connection.

Examples of name-value pairs are set out below:
Action=Authorise,
Trans ID=10409975342108,
Date=01/02/2011,
. . .

Connected to point-of-sale service object 1304 is session management service object 1306. Module 1306 is preferably a state machine that is driven by events. These events include timers and inputs from other modules. The state machine is controlled by computer executable scripts 1308. All actions and events are related to a session identifier that is unique to the session while it is in progress. All external inputs to the session management service object 1306 will use the session identifier to indicate the session to which the event relates.

The service broker module 1310 is responsible for ‘brokering’ connections between other modules. It is also responsible for alerting those modules of any communication breakdown necessitating a failover. All modules within a multi-server architecture must register with one or more brokers in order to know what other modules are running and the locations in the network.

Each module also maintains a ‘heartbeat’ with the broker 1310 in order that the broker can know the current running status of modules in the system. If a module fails or is stopped, the broker 1310 informs all other modules communicating with the failed module to seize and redirect traffic to other service providers.

The configuration broker service object 1312 is responsible for providing configurations to all other modules in the system requiring specific configuration. Configurations for each module are preferably determined from a single configuration file 1314.

Database reader service object 1316 performs database reads from a database 1318. Database reads are typically performed for the session management service object 1306. Additional operations are able to be performed for any module. Typically these include reading account information for the session management service object 1306 to use for verification purposes.

The database writer service object 1320 performs database writes. These writes are generally performed for the session management service object 1306. Alternatively the rights can be performed for any other module in the system. Typical write events include writing records to the database. These records are often known as transaction or call detail records.

International remittance service object 1322 is the arbiter between the session management service object 1306 and international remittance agent 1324. The international remittance service objection 1322 supports several different interface protocols for example http, web services and XML. The international remittance service object 1322 is configured to the particular international remittance provider API.

The m-wallet service object 1324 is the arbiter between the session management service object 1306 and a mobile wallet system 1326. The m-wallet service object 1324 supports several different interface protocols for example http, web services and XML. The m-wallet service object 1324 is configured to the particular wallet system interface API.

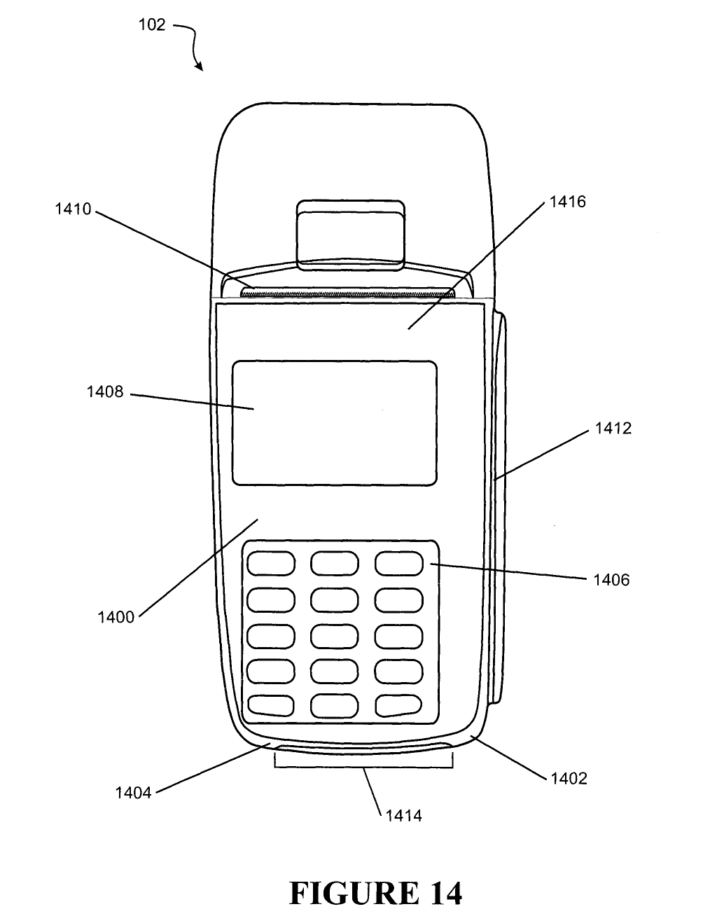

FIG. 14 shows a preferred form POS terminal 102. The device 102 includes computer processing and storage devices 1400. These are typically stored internally within the POS terminal 102 and include CPU, RAM and ROM. The RAM and ROM are examples of computer readable media.

A computer-useable or computer readable medium includes any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. A tangible computer-useable or tangible computer readable medium excludes transitory, propagating signals.

Also included is a power source 1402 including an AC/DC adaptor. Device 102 further includes a network communication device 1404. Typical devices 1404 include Ethernet, WiFi and wireless GPRS.

The typical POS terminal 102 also includes various user interface devices. These include data entry device 1406. Data entry device includes physical buttons, touch screen and haptic arrangements. The devices 1406 are either fixed to or detached from device 102.

The device 102 includes a display 1408. This display 1408 is preferably a digital display device for example an LCD or LED device. The display 1408 in one form is a touch screen and in another is a non-touch screen.

Also included is a printing device 1410, including thermal or inkjet arrangements. The printing device can be fixed or detached and is optional.

The preferred form device 102 also includes card reading devices. These include a magnetic stripe reading device 1412 and a chip card slot device 1414.

The device 102 further includes a contactless communication device 1416. This communication device 1416 includes near field communication, infrared and Bluetooth. The device 1416 could be fixed to or detached from the device 102.

It is envisaged that the above techniques for NFC merchant payments extend to ‘voucher redemption’. By collecting the NFC identifier and knowing the customer and merchant, the terminal can receive from the server the customer's vouchers, coupons or loyalty programs. The terminal then presents them on a graphical user interface (GUI) terminal touch screen. This has historically been the domain of the smart phone.

The techniques could also be applied to micro loan or micro finance payments as well as the spending of Government disbursements.

A benefit of the techniques described above is the potential to use an NFC sticker on any mobile phone or an NFC chip embedded in any smart phone. The secure element holding the PIN information is maintained securely on the server. It is the server that explicitly requests and verifies the PIN. The techniques described above potentially do not require credit card information or applications on the mobile device in order to process the transactions.

The foregoing describes the invention including preferred forms thereof. Modifications and improvements as would be obvious to those skilled in the art are intended to be incorporated in the scope hereof, as defined by the accompanying claims.

1. A method of conducting a money transfer transaction, the method comprising:
obtaining identification data from a customer at a point-of-sale terminal;
verifying the obtained identification data by matching the identification data with customer data maintained in computer memory;
obtaining transaction details from the customer, the transaction details including a transaction value and a recipient international mobile subscriber identity (IMSI) associated with a mobile device;
displaying a summary of the proposed money transfer transaction on a display device in communication with the point-of-sale terminal;
obtaining confirmation of the money transfer transaction from the customer;
obtaining payment from the customer representing the transaction value; and
associating the transaction value with the recipient IMSI.

2. The method of claim 1 wherein the identification data includes a biometric identifier.

3. The method of claim 1 wherein the identification data includes customer name and customer date of birth.

4. The method of claim 3 wherein verifying the obtained identification data includes the customer presenting a physical identifier, the physical identifier including a passport and/or driver license.

5. The method of claim 1 wherein the transaction details include a destination country.

6. The method of claim 5 wherein the point-of-sale device is located in a first country and the destination country comprises a second country.

7. The method of claim 1 wherein the transaction details include a currency.

8. A method of conducting a payment transaction, the method comprising:
obtaining identification data from a customer at a point-of-sale terminal;
verifying the obtained identification data by matching the identification data with customer data maintained in computer memory;
obtaining transaction details from the customer, the transaction details including a payee, a transaction value, and a transaction identifier;
displaying a summary of the proposed payment transaction on a display device in communication with the point-of-sale terminal;
obtaining confirmation of the payment transaction from the customer;
obtaining payment from the customer representing the transaction value; and
transferring remittance comprising the transaction value to a financial institution associated with the payee.

9. The method of claim 8 wherein the identification data includes a biometric identifier.

10. The method of claim 8 wherein the identification data includes a customer name and customer date of birth.

11. The method of claim 10 wherein verifying the obtained identification data includes the customer presenting a physical identifier, the physical identifier including a passport and/or driver license.

12. The method of claim 8 wherein the transaction details include a destination country.

13. The method of claim 12 wherein the point-of-sale device is located in a first country and the destination country comprises a second country.

14. The method of claim 8 wherein the transaction identifier comprises a payee reference number.

15. A method of conducting a payment transaction, the method comprising:
obtaining transaction details from a customer at a point-of-sale terminal, the transaction details including a transaction value and an international mobile subscriber identity (IMSI) associated with a mobile device;
initiating a push notification request to the IMSI, the push notification request including some or all of the transaction details and an authorisation request;
receiving an authorisation message from the mobile subscriber number; and
transferring remittance comprising the transaction value to a financial institution.

16. The method of claim 15 wherein obtaining the IMSI comprises obtaining an identifier of a Near Field Communication (NFC) chip associated with the mobile device and obtaining the IMSI from a data store of IMSI-NFC identifier associations.

17. The method of claim 15, wherein obtaining the IMSI comprises the customer entering the IMSI into a data entry device in communication with the point-of-sale terminal.

18. The method of claim 15 wherein the authorisation request comprises a request to enter a Personal Identification Number (PIN) on the mobile device associated with the IMSI.

19. A money transfer transaction system comprising:
an identification device configures to obtain identification data from a customer at a point-of-sale terminal;
a verification module configured to verify the obtained identification data by matching the identification data with customer data maintained in computer memory;
a data entry device configured to obtain transaction details from the customer, the transaction details including a transaction value and a recipient international mobile subscriber identity (IMSI) associated with a mobile device;
a display configured to display a summary of the proposed money transfer transaction; and
a remittance module configured to associate the transaction value with the recipient IMSI.

20. The system of claim 19 wherein the identification device comprises a biometric scanner, the identification data including a biometric identifier.

21. The system of claim 19 wherein the identification device comprises a data entry device, the identification data including a customer name and customer date of birth.

22. The system of claim 19 wherein the transaction details include a destination country.

23. The system of claim 22 wherein the point-of-sale device is located in a first country and the destination country comprises a second country.

24. The system of claim 19 wherein the transaction details include a currency.

25. A payment transaction system comprising:
an identification device configured to obtain identification data from a customer at a point-of-sale terminal;
a verification module configured to verify the obtained identification data by matching the identification data with customer data maintained in computer memory;
a data entry device configured to obtain transaction details from the customer, the transaction details including a payee, a transaction value, and a transaction identifier;
a display configured to display a summary of the proposed payment transaction;
a remittance module configured to transfer remittance comprising the transaction value to a financial institution associated with the payee.

26. The system of claim 25 wherein the identification device comprises a biometric scanner, the identification data including a biometric identifier.

27. The system of claim 25 wherein the identification device comprises a data entry device, the identification data including a customer name and customer date of birth.

28. The system of claim 25 wherein the transaction details include a destination country.

29. The system of claim 28 wherein the point-of-sale device is located in a first country and the destination country comprises a second country.

30. The system of claim 25 wherein the transaction identifier comprises a payee reference number.

31. A payment transaction system comprising:
an identification device configured to obtain transaction details from a customer at a point-of-sale terminal, the transaction details including a transaction value and an international mobile subscriber identity (IMSI) associated with a mobile device;
a messaging module configured to initiate a push notification request to the IMSI, the push notification request including some or all of the transaction details and an authorisation request; and
a remittance module configured to transfer remittance comprising the transaction value to a financial institution on receiving an authorisation message from the mobile subscriber number.

32. The system of claim 31 wherein the identification device comprises a contactless communication device, and wherein obtaining the IMSI comprises obtaining an identifier of a Near Field Communication (NFC) chip associated with the mobile device and obtaining the IMSI from a data store of IMSI-NFC identifier associations.

33. The system of claim 31 wherein the identification device comprises a data entry device, and wherein obtaining the IMSI comprises the customer entering the IMSI into a data entry device in communication with the point-of-sale terminal.

34. The system of claim 31 wherein the authorisation request comprises a request to enter a Personal Identification Number (PIN) on the mobile device associated with the IMSI.

35. A tangible computer-readable medium having stored thereon computer executable instructions that when executed by a processor cause the processor to perform a method of conducting a money transfer transaction, the method comprising:
obtaining identification data from a customer at a point-of-sale terminal;
verifying the obtained identification data by matching the identification data with customer data maintained in computer memory;
obtaining transaction details from the customer, the transaction details including a transaction value and a recipient international mobile subscriber identity (IMSI) associated with a mobile device;
displaying a summary of the proposed money transfer transaction on a display device in communication with the point-of-sale terminal;
obtaining confirmation of the money transfer transaction from the customer;
obtaining payment from the customer representing the transaction value; and
associating the transaction value with the recipient IMSI.

36. A tangible computer-readable medium having stored thereon computer executable instructions that when executed by a processor cause the processor to perform a method of conducting a payment transaction, the method comprising:
obtaining identification data from a customer at a point-of-sale terminal;
verifying the obtained identification data by matching the identification data with customer data maintained in computer memory;
obtaining transaction details from the customer, the transaction details including a payee, a transaction value, and a transaction identifier;
displaying a summary of the proposed payment transaction on a display device in communication with the point-of-sale terminal;
obtaining confirmation of the payment transaction from the customer;
obtaining payment from the customer representing the transaction value; and
transferring remittance comprising the transaction value to a financial institution associated with the payee.

37. A tangible computer-readable medium having stored thereon computer executable instructions that when executed by a processor cause the processor to perform a method of conducting a payment transaction, the method comprising:
obtaining transaction details from a customer at a point-of-sale terminal, the transaction details including a transaction value and an international mobile subscriber identity (IMSI) associated with a mobile device;
initiating a push notification request to the IMSI, the push notification request including some or all of the transaction details and an authorisation request;
receiving an authorisation message from the mobile subscriber number; and
transferring remittance comprising the transaction value to a financial institution.
